(19) United States
(12) Patent Application Publication
(10) Pub. No.: US 2006/0053926 A1
(43) Pub. Date: Mar. 16, 2006

(54) Apparatus and method for speed control

(75) Inventors: Mark Cooper, Pella, IA (US); Curt Graham, Lynnville, IA (US)

Correspondence Address: Merchant & Gould P.C., P.O. Box 2903, Minneapolis, MN, 55402-0903, US

(73) Assignee: Vermeer Manufacturing Company

(21) Appl. No.: 10/925,671

(22) Filed: Aug. 24, 2004

(51) Int. Cl. G05G 9/047

(52) U.S. Cl. 74/471 XY

(57) ABSTRACT

An operator control system including a control bracket and levers. The control bracket is positionable at first and second position. When the control bracket is positioned in the first position, the levers have a maximum range of travel corresponding to a maximum range of available speed. When the control bracket is positioned in the second position, the levers have a limited range of travel that is less than the maximum range of travel.

### TECHNICAL FIELD

This disclosure generally relates to hydraulic systems for machines wherein control of the maximum speed of an operation is desired.

### BACKGROUND

Various machines include hydraulic systems with motors and operator controls. The motors typically rotate a mechanical element, such as a gear or a wheel, in order to control the speed and/or direction of a machine function; an example being hydraulically powered, ground-engaging wheels or tracks wherein a hydraulic motor controls the speed and direction of travel of the machine over the ground. Another example is a hydraulically powered pinion gear, meshed with a rack gear, wherein the motor controls the direction and speed of linear travel of a machine element connected to the rack gear.

Conventional machine controls typically include a control lever operably interconnected to a hydraulic system. The control lever is usually biased to a center position, at which no flow is directed to a hydraulic motor, and thus there is no activation of the related machine function. From the center position, the control lever can be moved in two directions: a first direction to initiate operation in a first direction, and a second opposite direction to initiate operation in a second direction. The speed is often controlled by how far the control lever is moved from the center position. Generally, moving the lever further from the center position results in higher speed. The machine function typically operates at full speed when the lever is in a far-most position from the center position, in either direction.

When using such machines, different modes of operation are often needed, including a mode wherein full speed is needed or desirable, and a second mode wherein full speed is not desirable, but some consistent, reduced speed is needed or desirable. In the first mode of operation, the operator simply positions the control lever at the far-most position to achieve maximum speed. However, in the second mode, the operator is required to limit movement of the control lever to a position wherein the desired speed is produced. This second mode of operation requires the machine operator to concentrate closely on positioning the control lever in a desired, limited position, and on maintaining that desired position of the control lever. It is difficult for the operator to maintain this second mode of operation over an extended period of time, particularly if the operator is subjected to movement of the machine, which may in turn cause the control lever to move out of the desired position.

A need exists for a system to provide controlled speed of a hydraulically actuated system, wherein the operator is not required to precisely and manually position a control lever.

### SUMMARY

One aspect of the present disclosure relates to a machine having a variable speed rotary drive and a control system that controls the speed produced by the variable speed rotary drive. The control system includes a control lever having a maximum range of travel, the maximum range of travel corresponding to a range of available speed. The control system also includes a control bracket mounted to the machine, the control bracket being selectively moveable to first and second positions. Further, the control lever is moveable within the maximum range of travel when the control bracket is in the first position, and the control lever is moveable within a limited range of travel less than the maximum range of travel when the control bracket is in the second position.

Another aspect of the present disclosure relates to a method for controlling the speed output of a machine with a control lever that has a range of travel corresponding to a range of available speed. The method includes providing a control bracket having a stop element; positioning the control bracket in a first position at which the control lever is permitted to move through a first range of travel; and positioning the control bracket in a second position at which the stop element restricts travel of the control lever such that the control lever is permitted to move through a second range of travel less than the first range of travel.

Yet another aspect of the present disclosure relates to a control device for use in controlling a speed output of a machine having a control lever. The control device includes a control bracket configured to mount onto a machine. The control bracket is configured to be selectively positionable at first and second positions relative to a control lever of the machine. The control device also includes a stop element mounted to the control bracket. The stop element is configured to permit the control lever of the machine to travel through a full range of travel when the control bracket is positioned in the first position. The stop element is also configured to contact the control lever of the machine to limit travel of the control lever when the control bracket is position in the second position.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a side view of a machine including ground engaging wheels operated by hydraulic motors and controlled by a hydraulic system, the hydraulic system is controlled by one embodiment of an operator control system according to the principle of the present disclosure;

FIG. 2 is a top view of the machine of FIG. 1;

FIG. 3 is a partial cutaway, top view of one embodiment of a speed control bracket of the operator control system of FIG. 1;

FIG. 4 is a perspective view of the speed control bracket of FIG. 3;

FIG. 5 is a top view of the operator control system of FIG. 1, shown with the speed control bracket positioned in a limited travel position, and shown with a control lever positioned at a center position;

FIG. 6 is a schematic cross-section of the operator control system of FIG. 5, taken along line 6-6, shown with a hydraulic control valve and hydraulic system;

FIG. 7 is a top view of the operator control system of FIG. 1, shown with the speed control bracket positioned in the limited travel position, and shown with the control lever positioned at a maximum, limited position;

FIG. 8 is a schematic cross-section of the operator control system of FIG. 7, taken along line 8-8, shown with the hydraulic control valve and hydraulic system;

FIG. 9 is a top view of the operator control system of FIG. 1, shown with the speed control bracket positioned in a non-limited travel position, and shown with the control lever positioned at a maximum, non-limited position;

FIG. 10 is a schematic cross-section of the operator control system of FIG. 9, taken along line 10-10, shown with the hydraulic control valve and hydraulic system;

FIG. 11 is an exploded view of another machine including another embodiment of an operator control system according to the principle of the present disclosure; and

FIG. 12 is a perspective view of the operator control system of FIG. 11.

### DETAILED DESCRIPTION

Reference will now be made in detail to various features of the present disclosure that are illustrated in the accompanying drawings. Wherever possible, the same reference numbers will be used throughout the drawings to refer to the same or like parts.

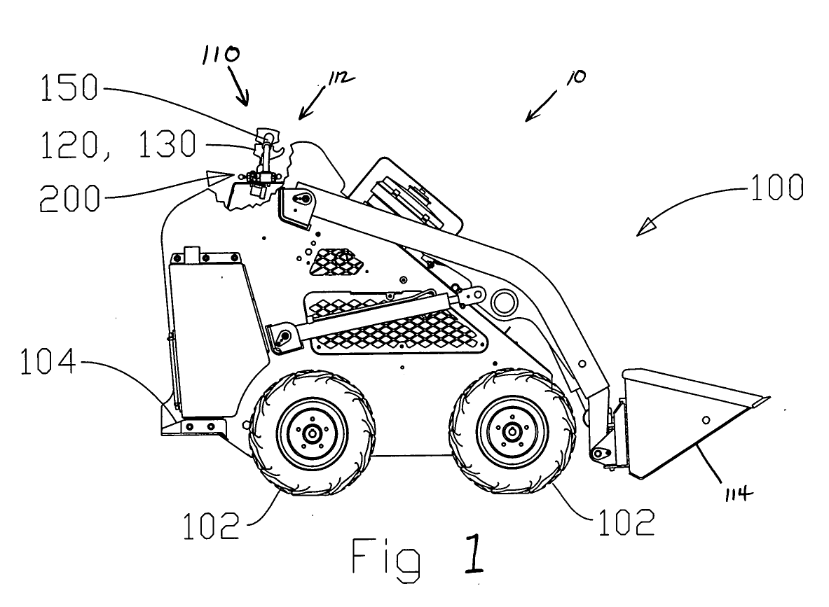

FIG. 1 illustrates a machine 10 incorporating one embodiment of an operator control system 110 in accord with the principles of the present disclosure. In the illustrated embodiment, the machine 10 is a skid loader 100 having a skid bucket 114. The skid loader 100 includes four wheels 102 that are driven by variable speed rotary drives in either a forward direction or a backward direction, at varying speeds. In the illustrated embodiment, the variable speed rotary drives are hydraulic motors 180 (shown schematically in FIG. 6) that provide a variable speed output in both the forward and rearward directions. While referred to as forward and backward directions, it will be appreciated that the direction of rotation need not be limited to a direction of vehicle travel, for example. Rather, the forward and backward directions are used for explanatory purposes of the illustrated embodiment. First and second directions that are not necessary associated with a forward or backward direction are within the scope of the present disclosure.

In use, an operator stands on a platform 104 located adjacent to an operator control area 112 of the skid loader 100. The control system 110 of the present disclosure is located in the operator control area 112. The control system 110 controls flow of hydraulic fluid to the hydraulic motors, which in turn, drive the wheels 102 of the skid loader 100. The control system 110 may also include other types of controls, for example, controls that cause the skid bucket 114 to lift and tilt, for example. Although the present control system 110 is described in application to a skid loader 100, it will be appreciated that the control system 110 can be used to control the rotational direction and speed of other functions on other types of machines. In the illustrated embodiment, handles 140, 150 are located in the operator control area 112. An operator may grasp the handles 140, 150 for stability while operating the skid loader 100.

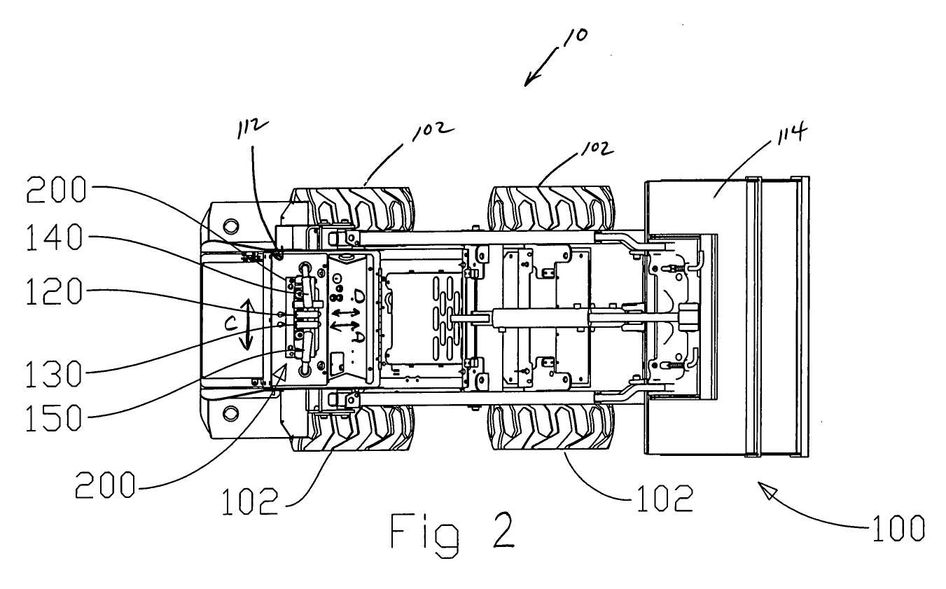

Referring now to FIG. 2, the direction of rotation and speed of rotation of the wheels 102 are controlled by first and second control levers 120, 130 of the control system 110. The first control lever 120 of the control system 110 is located on the left side of the skid loader 100 and controls the two left-side wheels 102 of the loader. The second control lever 130 is located on the right side of the skid loader 100 and controls the two right-side wheels 102.

The positions of the first and second control levers 120, 130 determine the rotational direction and speed of the wheels 102. For example, when the first control lever 120 is pushed forward from a center or neutral position (toward the bucket 114), the wheels 102 on the left side of the loader 100 rotate clockwise. If the first control lever 120 is pulled rearward from the center position (toward the platform 104), the wheels 102 on the left side of the loader 100 rotate counter-clockwise. In addition, if the first control lever 120 is pushed only partially forward, the speed of rotation in the clockwise direction will be less than if the lever 120 were pushed completely forward.

Similarly, when the second control lever 130 is pushed forward from a center or neutral position, the wheels 102 on the right side of the loader 100 rotate clockwise; and when the lever 130 is pulled rearward, the wheels rotate counter-clockwise. Also, pushing the second control lever 130 only partially forward provides a reduced rotational speed than if the lever were pushed completely forward. As can be understood, the speed of rotation in the counter-clockwise direction is controlled in the same manner as previously described when the levers 120, 130 are pulled in the rearward.

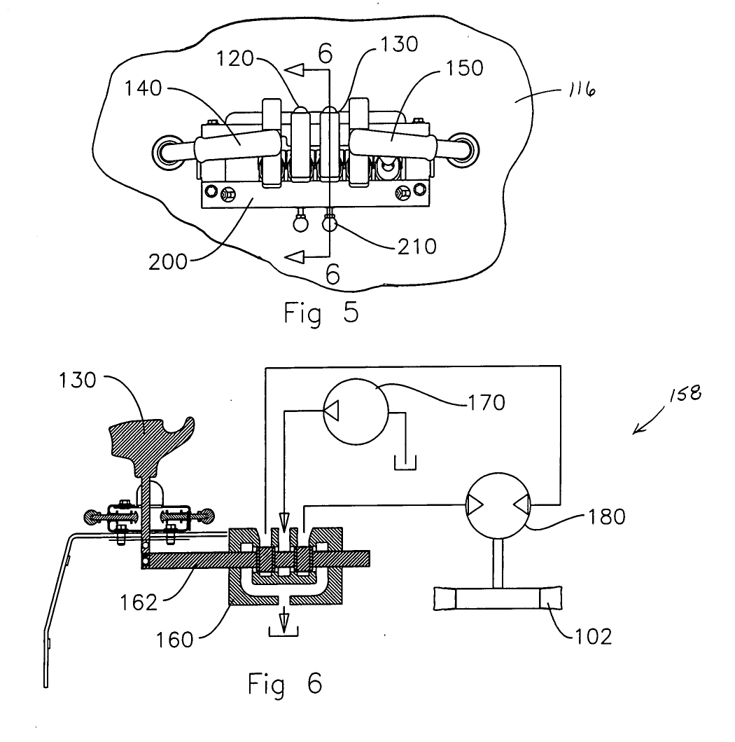

Referring now to FIGS. 2-4, the control system 110 of the present disclosure includes a speed control bracket 200. The speed control bracket 200 is mounted to a frame member 116 (e.g. FIG. 5) of the skid steer loader 100 with bolts 106 (FIG. 4). The bolts pass through slots or elongated apertures 206 formed in the speed control bracket 200. The slots 206 of the speed control bracket 200 permit the bracket 200 to be positioned in first and second positions relative to the first and second control levers 120, 130. The first and second positions of the bracket 200 correspond to first and second modes of operation of the machine 10, as will be described in greater detail hereinafter. In the illustrated embodiment, the ends of the slots 206 define the first and second positions of the speed control bracket 200.

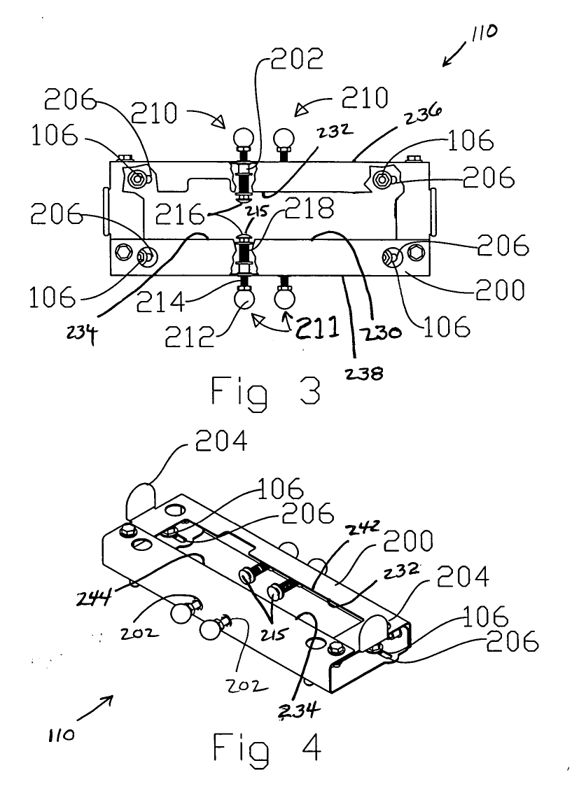

Each of the first and second control levers 120, 130 extends through an opening 230 (FIG. 3) of the bracket 200. Referring now to FIGS. 3 and 4, the opening 203 of the speed control bracket 200 is at least partially defined by edges 232, 234 of first and second bracket members 236, 238. In the first mode of operation of the machine 10, the front edge 232 of the opening 230 defines a first fixed stop 242 that limits travel of the control levers 120, 130 beyond a maximum forward position at which full speed in the clockwise direction is achieved. Likewise, the back edge 234 of the opening 230 defines a second fixed stop 244 that limits travel of the control levers 120, 130 beyond a maximum rearward position at which full speed in the counter-clockwise direction is achieved (i.e. full reverse speed). Thus, each of the first and second lever 120, 130 has a maximum range of travel defined by the first and second fixed stops 242, 244 of the speed control bracket 200 when the speed control bracket 200 is positioned in the first position.

The maximum range of travel is provided when the speed control bracket 200 is positioned in the first position relative to the lever 120, 130. The first position is a “non-limited” position at which the levers can be positioned at any position between and including the maximum rearward and forward positions defined by the first and second fixed stops 242, 244. As can be understood, the maximum range of travel of the levers 120, 130 corresponds to the maximum range of available speed that can be provided by the variable speed rotary drives.

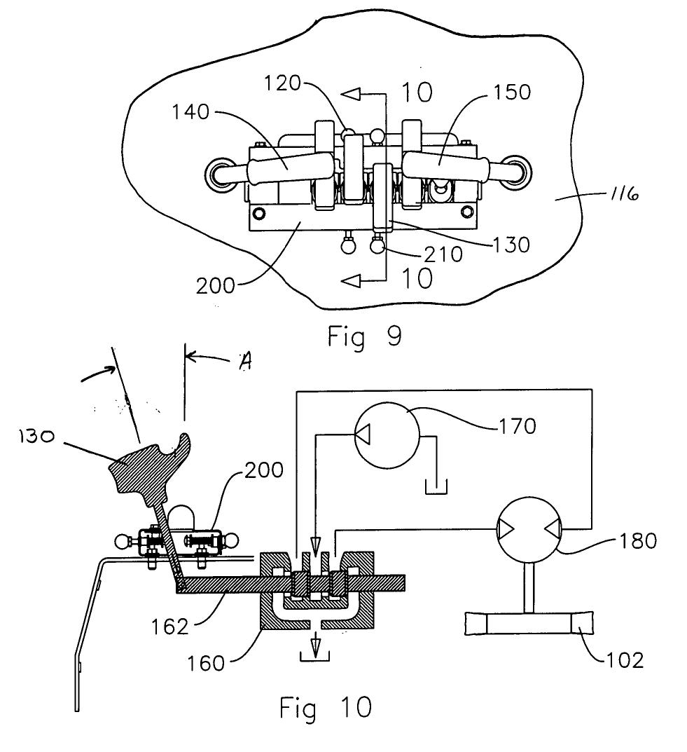

In use, when an operator wishes to have access to the maximum range of available speed provided by the variable speed rotary drives, the operator positions the speed control bracket 200 in the first non-limited position (FIG. 9). In particular, the operator slides the speed control bracket 200 in a direction C (FIG. 2) generally perpendicular to the direction of movement D of the levers 120, 130. Typically, the speed control bracket 200 is slid in the direction C until the bolt 106 contact the corresponding end of the slot 206. To achieve maximum speed in the forward direction, for example, the operator pushes one or both the control levers 120, 130 to the maximum non-limited position, i.e., the position where further travel of the lever is stopped by the fixed stop 242. The operator then holds the control lever against the fixed stop 242. In this position, the operator can easily maintain a constant speed by holding the lever against the fixed stop 242 during operation of the machine.

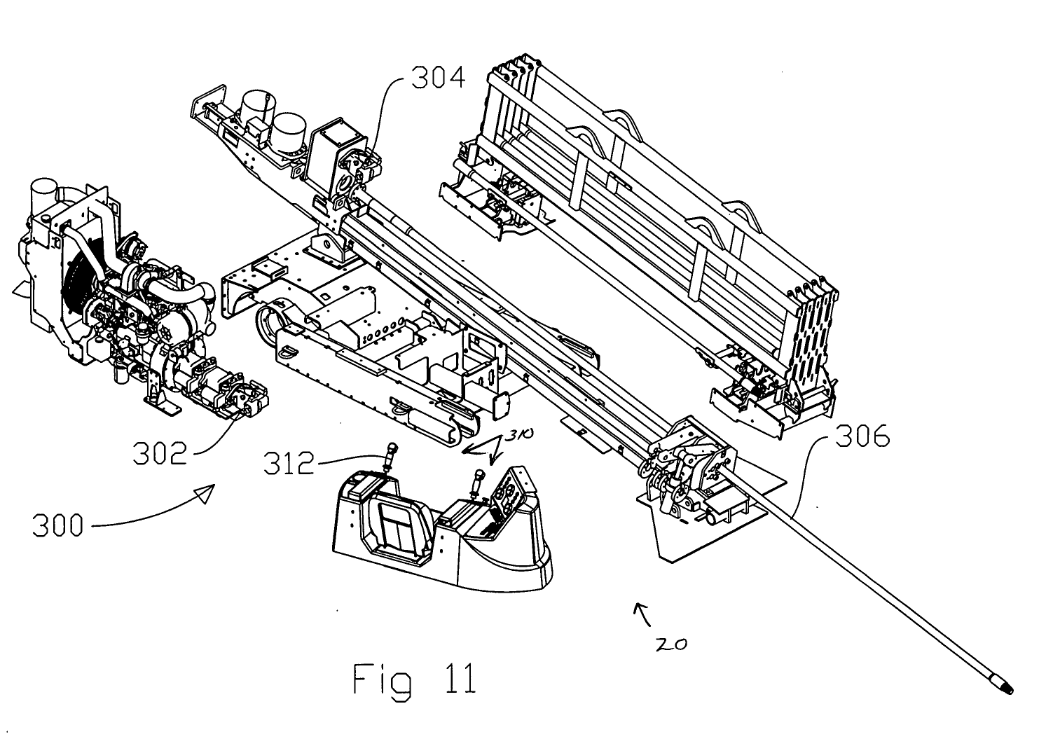

Referring to FIGS. 9 and 10, the control levers 120, 130 can be moved forward and rearward to each of the respective maximum, non-limited positions. In each of the maximum non-limited positions, full speed, in either a forward direction or a rearward direction is achieved. Operation of the machine 10 in this configuration (i.e. the speed control bracket positioned in the first non-limited position) permits an operator to operate the machine 10 in the first mode of operation wherein any speed output within the range of available speed can be achieved.

To operate the machine 10 in the second mode of operation, the speed control bracket 200 of the present invention is moved from the first non-limited position to the second position. The second position of the speed control bracket 200 can be referred to a limited position because the range of travel of the first and second control levers 120, 130 is limited. In particular, the levers can be positioned at any position between and including a maximum, limited position in a forward direction and a maximum, limited position in a rearward direction. In other words, each of the first and second lever 120, 130 has a limited range of travel. The limited range of travel in the second mode of operation is less than the maximum range of travel of the first mode of operation previously described.

Referring again to FIGS. 3 and 4, to limit the range of lever travel, the control system 110 includes speed control stops, including first and second forward speed control stops 210 and first and second rearward speed control stops 211. The speed control stops are interconnected to the speed control bracket 200. Each of the speed control stops 210, 211 includes a knob 212, a threaded portion 214, a stop element 215 having a stopping surface 216, and a spring 218.

The speed control stops 210, 211 interact with the control levers 120, 130 to restrict forward and rearward travel or movement of the control levers 120, 130 such that the maximum speed that can be obtained is less than full available speed. The limited range of travel of the control levers is defined by the first and second speed control stops 210, 211 of the speed control bracket 200 when the speed control bracket 200 is positioned in the second position. With the speed control bracket in the second position, the operator is able to move and hold the control lever 120 or 130 against the speed control stops 210, 211 of the speed control bracket 200 to provide a controlled, limited speed. As can be understood, speed that can be achieved in this second mode of operation is less than the full speed that can be achieved in the first mode of operation.

In the preferred embodiment, the speed control stops 210, 211 are adjustable to selectively vary the limited range of travel of the control levers 120, 130. In particular, the speed control bracket 200 includes threaded apertures 202 (FIGS. 3 and 4) that receive each of the speed control stops 210, 211. The threaded portion 214 of the speed control stop 210 mates with threaded aperture 202 of the speed control bracket 200. The position of the stop surface 216 of the stops 210, 211 relative to the speed control bracket 200 can be adjusted by rotating the knob 212 to either further engage or disengage the threaded portion 214 of the stops 210, 211 with the threaded aperture 202 of the bracket 200. This adjustment allows the operator to adjust the maximum, limited speed of operation in the second mode of operation.

Referring now to FIG. 4, the illustrated speed control bracket includes tabs 204 located on opposite sides of the speed control bracket 200. The tabs 204 can be used to conveniently shift or move the speed control bracket 200 between the first and second positions. For example, the tabs 204 extend upward from the bracket 200 and are located such that the operator can shift the bracket 200 between the first and second positions, while still holding onto the handles 140 and 150 of the machine 10. That way, the operator can continue to operate the machine 10 while shifting the speed control bracket 200 between first and second positions. In other words, the operator does not have to stop operation of the machine 10 to change the machine from the first mode of operation to the second mode of operation, or vise versa.

FIGS. 5 to 10 illustrates various positioning of the second control lever 130 in the first and second modes of operation. A schematic representation of the interaction of the second control lever 130 with a hydraulic system 158 of the machine 10 is also illustrated. Referring first to FIGS. 5 and 6, the speed control bracket 200 is shown in the second limited position. The control levers 120, 130 are located in the center or neutral position.

The hydraulic system 158 of the machine 10 includes a valve 160, a control spool 162, a pump 170, and a motor 180. When the control lever, e.g. 130, is positioned in the neutral position, the control spool 162 of the hydraulic system 158 is positioned such that no flow from the pump 170 to the motor 180 is permitted. In the neutral position, the wheels 102 of the machine 10 do not rotate.

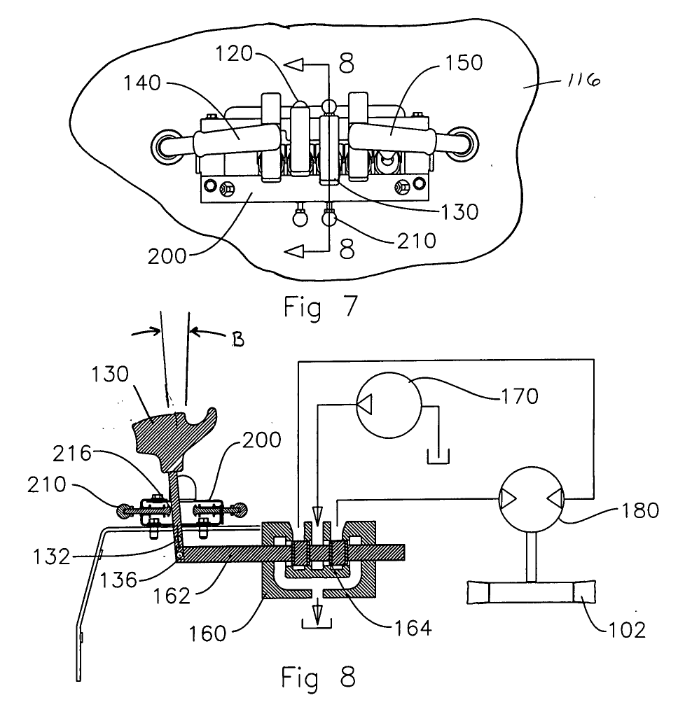

In each of FIGS. 5-8, the speed control bracket 200 is positioned in the second position where movement of the control levers 120, 130 is restricted such that the maximum limited speed that can be obtained is less than full available speed. In particular, the maximum travel distance of the control levers 120, 130 is restricted by contact with the stop surfaces 216 of the speed control stops 210, 211. FIGS. 7 and 8 illustrate the control lever 130 in a maximum, limited, rearward position. When the control lever 130 is moved rearward as shown, the control lever 130 rotates around a pivot point 132. The control lever 130 is configured to pivot about the pivot point 132 an angular distance B until the lever 130 contacts the speed control stop 210.

A bottom end 136 of the control lever 130 is coupled to the control spool 162 to move the control spool 162 into a first open position when the control lever rotates around the pivot point 132. At the first open position, hydraulic oil flows from the pump 170, through an opening 164, and to the motor 180.

In the illustrated embodiment, the opening 164 is defined by a tapered construction and acts to restrict the flow to control the flow rate of hydraulic oil. By controlling the flow rate of hydraulic oil, the rate of rotation of the motor 180 is controlled. In this position, the operator is able to hold the control lever 130 in a stopped position, as set by speed control stop 210, while the hydraulic system is rotating the wheel 102 at a speed less than full speed.

FIGS. 9 and 10 illustrate the speed control bracket 200 in the first non-limited position where is full speed is available. The speed control bracket 200 is positioned such that the speed control stops 210, 211 do not affect the travel of the control lever 130. When the control lever 130 is moved rearward as shown, the control lever 130 rotates around the pivot point 132. The control lever 130 is configured to pivot about the pivot point 132 an angular distance A until the lever 130 contact the edge 234, or fixed stop 244 of the bracket 200. As can be understood, the angular distance A is greater than the angular distance B.

The bottom end 136 of the control lever 130 acts on the control spool 162 to move the control spool 162 into a second open position when the control lever 130 pivots the angular distance A. At the second open position, the hydraulic oil flows from the pump 170, through the opening 164, and to the motor 180. The opening 164 has a greater cross-sectional area to permit greater flow through the opening when the control spool 162 is in the second open position.

FIG. 11 illustrates an alternative machine 20 incorporating another embodiment of an operator control system 310 of the present disclosure. The illustrated alterative machine 20 is a horizontal directional drill machine 300 having a pump 302 and a motor 304. The pump 302 and motor 304 rotate and drive drill rods 306. In this embodiment, the operator control system 310 includes a single control lever 312 mounted in relation to a speed control bracket 320. The control lever 312 controls the speed and direction of rotation of the drill rods 306.

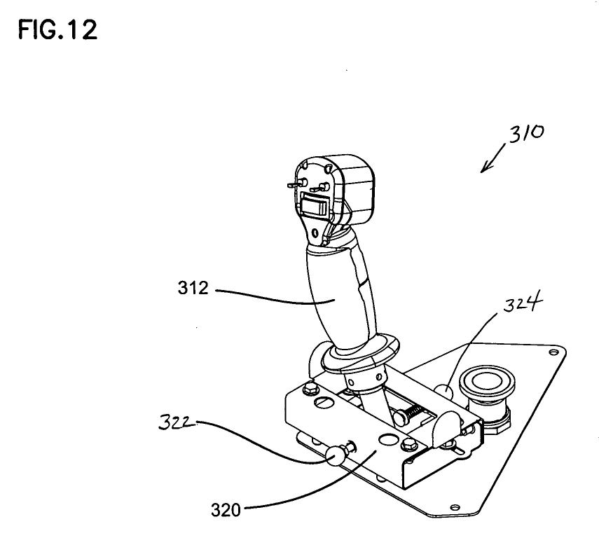

Similar to the previous embodiment, the speed control bracket 320 is configured to provide two modes of operation. In a first mode of operation, the speed control bracket 320 is positioned in a first non-limited position where speed control stops 322, 324 (shown in FIG. 12) do not affect the travel of lever 312, and full speed can be achieved. In a second mode of operation, as shown in FIG. 12, the speed control bracket 320 is positioned at a second limited position where the speed control stops 322, 324 restrict travel of lever 312 and speed is limited to less than full speed. In some applications, controlled limited speed provided by the second mode of operation may be desirable during specific operation of the horizontal drill machine, such as during a pull-back operation when the drill string is being pulled-back while rotating a large diameter cutting tool. Likewise, the first mode of operation, at which full speed is available, may be desirable for the other operations of the machine 20.

Various principles of the embodiments included in the present disclosure may be used in other applications. The above specification provides a complete description of the present invention. Since many embodiments of the invention can be made without departing from the spirit and scope of the invention, certain aspects of the invention reside in the claims hereinafter appended.

What is claimed is:

1. A machine, comprising:
a variable speed rotary drive;
a control system that controls the speed produced by the variable speed rotary drive, the control system including:
a) a control lever having a maximum range of travel, the maximum range of travel corresponding to a range of available speed;
b) a control bracket mounted to the machine, the control bracket being selectively moveable to first and second positions;
c) wherein the control lever is moveable within the maximum range of travel when the control bracket is in the first position, and wherein the control lever is moveable within a limited range of travel less than the maximum range of travel when the control bracket is in the second position.

2. The machine of claim 1, wherein the control bracket includes a stop element that limits movement of the control lever when the control bracket is positioned in the second position.

3. The machine of claim 2, wherein the control bracket has a pair of stop elements, including a first stop element that limits movement of the control lever in a first direction and a second stop element that limits movement of the control lever in a second direction.

4. The machine of claim 3, wherein the variable speed rotary drive includes two control levers and the control bracket includes two pairs of stop elements.

5. The machine of claim 4, wherein the variable speed rotary drive includes a hydraulic system.

6. The machine of claim 2, wherein the stop element is adjustable to selectively vary the limited range of travel of the control lever.

7. The machine of claim 1, wherein the control bracket includes tabs to slide the control bracket to the first and second positions.

8. The machine of claim 7, wherein the tabs extending upward from sides of the control bracket.

9. The machine of claim 7, wherein the machine includes handles, the tabs being located adjacent to the handles so that an operator can slide the control bracket to the first and second positions without releasing the handles.

10. A method for controlling the speed output of a machine with a control lever that has a range of travel corresponding to a range of available speed, the method comprising:
providing a control bracket having a stop element;
positioning the control bracket in a first position at which the control lever is permitted to move through a first range of travel; and
positioning the control bracket in a second position at which the stop element restricts travel of the control lever such that the control lever is permitted to move through a second range of travel less than the first range of travel.

11. The method of claim 10, wherein the control bracket has a pair of stop elements, including a first stop element that limits travel of the control lever in a first direction, and a second stop element that limits travel of the control lever in a second direction.

12. The method of claim 10, wherein the steps of positioning the control bracket in the first and second positions includes sliding the control bracket to the respective position.

13. A control device for use in controlling a speed output of a machine having a control lever, the control device comprising:
a control bracket configured to mount onto a machine, the control bracket being configured to be selectively positionable at first and second positions relative to a control lever of the machine; and
a stop element mounted to the control bracket, the stop element being configured to permit the control lever of the machine to travel through a full range of travel when the control bracket is positioned in the first position, the stop element further being configured to contact the control lever of the machine to limit travel of the control lever when the control bracket is position in the second position.

14. The control device of claim 13, wherein the stop element is adjustable to vary the travel limited by contact between the control lever and the stop element.

15. The control device of claim 14, wherein the stop element includes a threaded rod that engages a threaded hole in the control bracket to selectively position the stop element relative to the control bracket.

16. The control device of claim 13, further including a pair of stop elements, including a first stop element and a second stop element, the first stop element corresponding to a speed output in a first direction, the second stop element corresponding to a speed output in a second direction.

17. The control device of claim 13, further including a first pair of stop element and a second pair of stop element, one of the stop elements of each of the pairs of stop elements corresponding to a speed output in a first direction, the other of the stop elements of each of the pairs of stop elements corresponding to a speed output in a second direction.
